(19) United States
(12) Patent Application Publication
(10) Pub. No.: US 2001/0027453 A1
(43) Pub. Date: Oct. 4, 2001

(54) Distributed data processing system and method of processing data in distributed data processing system

(76) Inventor: Akio Suto, Minamiashigara-shi (JP)

Correspondence Address: SUGHRUE, MION, ZINN, MACPEAK & SEAS, PLLC, 2100 Pennsylvania Avenue, N.W., Washington, DC, 20037-3213, US

(21) Appl. No.: 09/819,612

(22) Filed: Mar. 29, 2001

(30) Foreign Application Priority Data
Mar. 29, 2000 (JP) 2000-091826
Mar. 30, 2000 (JP) 2000-093256
Mar. 1, 2001 (JP) 2001-057120

(51) Int. Cl. G06F 17/30

(52) U.S. Cl. 707/10; 707/200

(57) ABSTRACT

When a database of a database memory of a server is updated by a distributed data processing process performed by clients on an object to be controlled, a replication trigger generator generates a replication trigger. Based on the replication trigger, an updating information transfer unit transfers updating information to another server. A database updating processor of the server which has received the updating information updates the database stored in the database memory.

### BACKGROUND OF THE INVENTION

1. Field of the Invention

The present invention relates to a distributed data processing system comprising a plurality of servers and a plurality of clients connected to the servers for performing a distributed data processing process on an object to be controlled, and a method of processing data in such a distributed data processing system.

2. Description of the Related Art

Advances in recent years in information processors and information processing technology have led to widespread computer processing practices in various fields. For example, there are well known online data processing systems for financial institutions. Such online data processing systems are of a fully duplex configuration for recovery from a system failure. Specifically, the duplex system is made up of an active system and a backup system, and in the event of a failure of the active system, the active system switches to the backup system to give continued services to customers.

In order to allow the active system to switch to the backup system at any time, each of the active system and the backup system has a database of data to be processed by the system and information required by the system for processing the data. When data of the database of the active system is updated as a result of its data processing operation, corresponding data of the database of the backup system is also updated, so that the databases of the active and backup systems will contain the same data at all times.

At the time the database of the backup system is to be equalized with the database of the active system, the backup system is merely kept in a standby mode and does not perform any data processing operation. The active system simply needs to send an instruction to write updated data in the database to the backup system. As a consequence, it is not necessary to perform a conflict control process for accessing the database.

The above online data processing systems have a large system scale and tend to impose substantial adverse effects on the society in the event of system failures. Therefore, it has been recognized in the art that the cost of hardware and software solutions required to realize the fully duplex system design is unavoidable.

Smaller-size systems such as in-house information processing systems usually do not incorporate the above fully duplex principles because available resources are limited and should effectively be utilized. Such systems are often constructed such that while in operation the backup system performs another process different from the task that the active system processes.

Recent computers are becoming smaller in size and better in capability, and incorporate high-speed processors and large-capacity main memories and hard disks at lower costs.

In view of these advantages, many in-house information processing systems comprise a plurality of servers and a plurality of clients connected to the servers for performing distributed processing of data for the servers.

For such in-house information processing systems, there have been proposed various database backup functions to keep the same data in the databases of the servers, pass the processing from one server to another if the former server suffers a fault, and recover the database of a server, which has been broken or otherwise failed, using the database of another server that is operating normally.

For example, some proposed database backup functions keep the same data in the databases of the servers and recover files in the database of a server that suffers a fault, using the data in the database of another server (see Japanese laid-open patent publication No. 7-114495, and Japanese laid-open patent publication No. 5-265829). According to a known database backup process, data to be backed up are collected in an archive file, so that they can be backed up in a shortened period of time (see Japanese laid-open patent publication No. 11-53240).

FIG. 6 of the accompanying drawings shows a process of recovering the database of a server, which has been broken or otherwise failed, using the database of another server that is operating normally.

A distributed data processing system shown in FIG. 6 has a plurality of servers 1, 2 and clients 3, 4 which are connected to each other by communication cables 5 such as of a LAN. The servers 1, 2 have respective database memories 6, 7 which stores respective databases. The servers 1, 2 are constructed to process processing requests from the clients 3, 4 in a distributed manner. The servers 1, 2 and the clients 3, 4 have respective server applications 1b, 2b and user applications 3a, 4a that have been accumulated depending on tasks to be processed by the distributed data processing system. The user applications 3a, 4a perform given processing sequences.

For updating data in the databases of the servers 1, 2 based on processing requests from the clients 3, 4, the servers 1, 2 communicate with each other with replication processors 1a, 2a and reflect updated data in their databases in the each other's databases, thus equalizing the data in their databases.

If the database of one of the servers 1, 2, e.g., the server 2, suffers a fault and the data stored in the database are broken for some reason, then the data in the faulty database are recovered using the data in the database of the server 1 which is normal.

Heretofore, it has been customary to recover the data in the faulty database using export and import functions of the databases, as follows:

The processing operation of the clients 3, 4 is stopped, and the data in the database memory 6 is stored into a backup data memory 6a using the export function of a backup processor 8a of the normal server 1. Then, the data in the backup data memory 6a is imported to the database memory 7 using the import function of a backup processor 9a of the server 2, thus allowing the database memory 7 to reflect the database data updated after the database has suffered the fault until the system shutdown. Thereafter, the distributed data processing system resumes its operation.

The export and import functions perform the following processing: According to the export function, the data in the database are divided into information about table definition, information about data, information about index definition, information about trigger definition, and information about matching limitation, and these items of information are stored in the backup data memories 6a, 7a. The above data processing is carried out in order to minimize the amount of data handled, so that the backup data memories 6a, 7a have a sufficient storage capacity available for storing the above information. According to the import function, the database is reconstructed from the divided data.

When the database is backed up using the above export and import functions, hardware resources for storing the data can be saved, but the process of recovering the database is time-consuming.

For example, a processing time according to the import function in a general database depends greatly on the index definition of the database. Specifically, the time required to reconstruct indexes depends on the amount of data, the number of indexes, and the number of fields (the number of columns) of tables used in the indexes, and is determined as follows:

Construction time=the amount of data×the number of indexes×the number of fields used×the processing time per field

Databases in production systems contain a large amount of data for an achievement table, etc., and user applications in such production systems need to retrieve data quickly from the table from many viewpoints. Therefore, a plurality of definitions are given for both the number of indexes and the number of fields used. Accordingly, a long import processing time is required. Systems which are required to process databases from various viewpoints, other than production systems, also require a long time for import processing.

While a database is being recovered, it is necessary to stop the processing of a server which operates normally, and hence to shut down the entire distributed data processing system. This is because if a normally operating server accepted a processing request from a client and updated its database while a faulty database is being recovered, then the data in the database of the normal server and the data in the database being recovered would not agree with each other.

In applications such as machine equipment control (hereinafter referred to as process control) and production management for production lines in factories that need to operate 24 hours a day, if a system downtime required to recover a database from a fault is unduly long, then it will greatly affect the production efficiency.

There is known a cluster system where a plurality of servers of a distributed data processing system monitor each other, and when a fault occurs in either one of the servers, all functions are shifted to a normal server in order to avoid the shutdown of the distributed data processing system.

However, the conventional cluster system is applied to function faults at higher levels such as hardware and OS levels, but not to function faults at lower levels such as database levels. The conventional cluster system needs a certain period of time to check the statuses of the servers and effect server switching upon a fault. Furthermore, the conventional cluster system is disadvantageous in that its cost increases due to the allocation of a plurality of communication addresses shared by the servers.

If the conventional cluster system is incorporated in a production system which is an OLTP (On-Line Transaction Processing) system that performs data processing such as updating, insertion, deletion in the databases, then the overall system is shut off during a server switching. Since the system automatically recovers from the shutdown when the server switching is completed, each of the clients needs some means for recognizing a fault. However, because the cluster system uses a plurality of shared communication addresses, all the communication addresses are taken over by a normally operating server upon the occurrence of a fault. Thus, it is difficult to construct a means for monitoring a server change in each of the clients.

### SUMMARY OF THE INVENTION

It is a general object of the present invention to provide a distributed data processing system which comprises a plurality of servers and a plurality of clients connected to the servers, the distributed data processing system being capable of continuing a processing sequence without a system shutdown in the event of a fault of any of the servers, and a method of processing data in such a distributed data processing system.

Another object of the present invention is to provide a distributed data processing system which comprises a plurality of servers and a plurality of clients connected to the servers, the distributed data processing system being capable of, in the event of a fault of any of the servers, quickly switching a client connected to the faulty server to a fault-free server under the client management and continuing a processing sequence, and a method of processing data in such a distributed data processing system.

Still another object of the present invention is to provide a distributed data processing system which comprises a plurality of servers and a plurality of clients connected to the servers, the distributed data processing system being capable of quickly recovering a database without a system shutdown over a long period of time in the event of a fault of any of the servers, and a method of processing data in such a distributed data processing system.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram of a distributed data processing system according to the present invention;

FIG. 2 is a block diagram of an arrangement where the distributed data processing system according to the present invention is incorporated in a production line;

FIG. 3 is a block diagram of a system configuration for controlling the connection of clients in the distributed data processing system according to the present invention;

FIG. 4 is a flowchart of a processing sequence of a database updating processor in the distributed data processing system according to the present invention;

FIG. 5 is a flowchart of a processing sequence of an updating information transfer unit in the distributed data processing system according to the present invention; and

FIG. 6 is a block diagram of a conventional distributed data processing system.

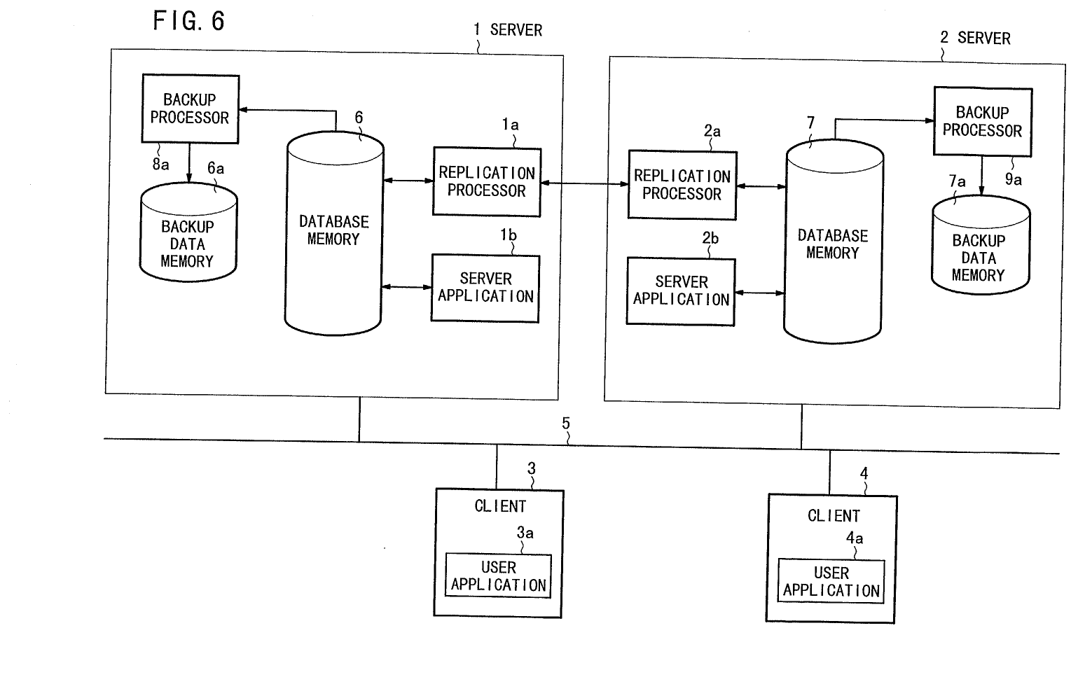

### DESCRIPTION OF THE PREFERRED EMBODIMENT

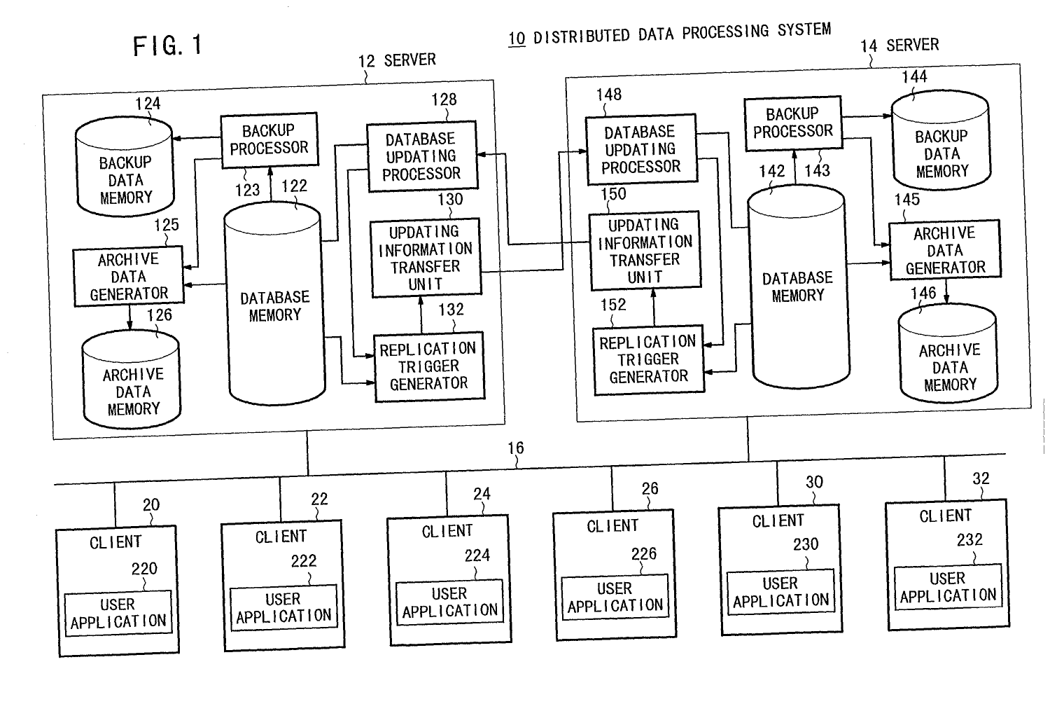

FIG. 1 shows in block form a distributed data processing system 10 according to the present invention. The distributed data processing system 10 comprises a plurality of servers 12, 14 and a plurality of clients 20, 22, 24, 26, 30, 32 which are connected to each other by communication cables 16 such as of a LAN.

When the distributed data processing system 10 is operating normally, the server 12 and the clients 20, 22, 24, 26, for example, carry out the processing of a process control system of a production line, e.g., the processing of a control process for controlling a production machine for manufacturing photographic films, and the server 14 and the clients 30, 32 carry out the processing of a production management system for managing production plans, raw materials, and inventories.

The server 12, which is a server for carrying out the processing of a process control system, basically comprises a database memory 122 for storing data such as production instruction information, manufacturing history information, etc., to be described la ter on, sent and received between the clients 20, 22, 24, 26, a backup processor 123 for backing up the data in the database memory 122 on-line at certain time intervals and storing the backed-up data in a backup database memory 124, an archive data generator 125 for generating archive data based on updating information of the database stored in the database memory 122 and updated by the clients 20, 22, 24, 26 and storing the archive data in an archive data memory 126, a replication trigger generator 132 for generating a data replication trigger based on a database updating process carried out by the clients 20, 22, 24, 26, an updating information transfer unit 130 for transferring the updating information of the database to the other server 14 based on the data replication trigger, and a database updating processor 128 for updating the data in the database memory 122 based on a request for updating the database.

The archive data generator 125 serves to generate archive data according to new updating information after the database in the database memory 122 is backed up in the backup data memory 124. The archive data stored in the archive data memory 126 before the database in the database memory 122 starts to be backed up is discarded. The database in the database memory 122 may be backed up in the backup data memory 124 at any desired time intervals set by the operator. For example, the database in the database memory 122 may be backed up in the backup data memory 124 periodically at intervals of a day, i.e., 24 hours. All the archive data after a backup process starts until a next backup process starts is stored in the archive data memory 126. The updating information transfer unit 130 transfers the updating information at certain time intervals set by the system administrator.

The server 14, which is a server for carrying out the processing of a production management system, has a database memory 142 for storing data of production plans, raw materials, and inventories generated between the clients 30, 32. The server 14 also has a backup processor 143, a backup data memory 144, an archive data generator 145, an archive data memory 146, a database updating processor 148, an updating information transfer unit 150, and a replication trigger generator 152, which are identical to those of the server 12.

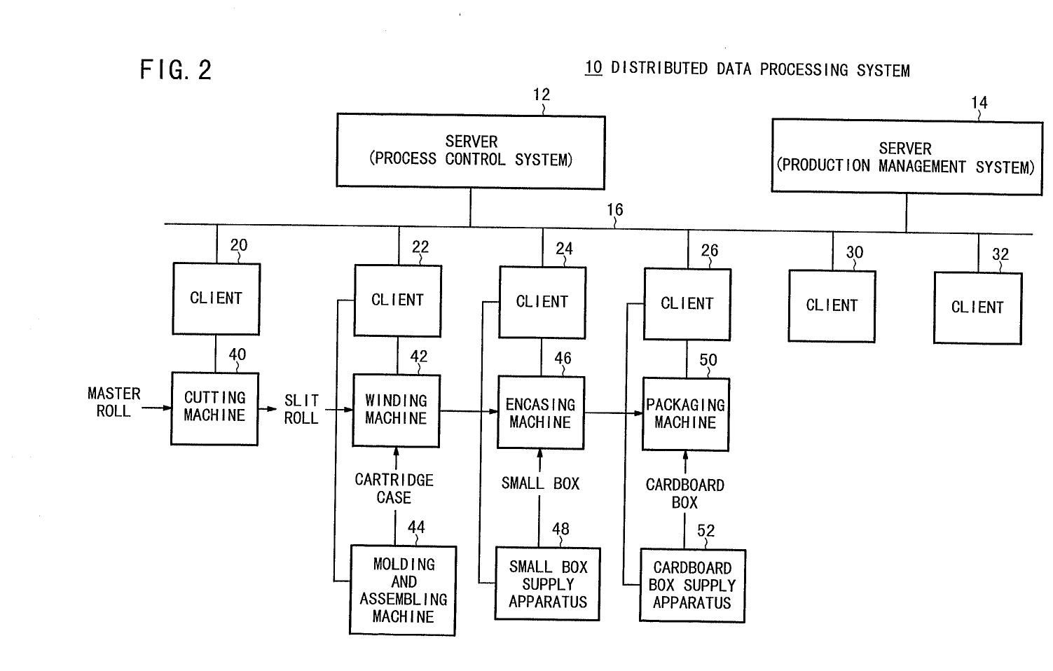

As shown in FIG. 2, the clients 20, 22, 24, 26 have respective user applications 220, 222, 224, 226 which, based on production instruction information from the server 12, control a cutting machine 40, a winding machine 42, an encasing machine 46, and a packaging machine 50, respectively, and transmits manufacturing history information collected from these machines to the server 12. Similarly, the clients 30, 32 have respective user applications 230, 232 for performing tasks including production plans, raw material purchase management processes, and product inventory management processes between themselves and the server 14.

The cutting machine 40 that is controlled by the client 20 cuts off a master roll of a photographic film material to a certain width to produce a slit roll. The winding machine 42 controlled by the client 22 winds the slit roll supplied from the cutting machine 40 into a cartridge case that is molded and assembled by a molding and assembling machine 44. The encasing machine 46 controlled by the client 24 encases a film cartridge with a small box supplied from a small box supply apparatus 48. The packaging machine 50 controlled by the client 26 packages the film cartridge encased in the small box with a cardboard box supplied from a cardboard box supply apparatus 52.

Each of the servers 12, 14 and the clients 20, 22, 24, 26, 30, 32 has a hardware arrangement comprising a processor, a main memory, a hard disk, a network interface, etc. as with a general personal computer. The machines and the user applications described above are operated under the control of operating systems that are installed in the servers 12, 14 and the clients 20, 22, 24, 26, 30, 32.

A normal mode of operation of the distributed data processing system 10 will be described below with reference to FIG. 2.

First, the client 20 receives individual production instruction information from the server 12 and displays the received individual production instruction information on a display monitor screen. The other clients 22, 24, 26 operate in the same manner as the client 20.

The individual production instruction information is generated by the clients 30, 32 connected to the server 14, and transmitted from the server 14 to the server 12. Information collected from the clients 20, 22, 24, 26 by the server 12 is transmitted from the server 12 to the server 14.

The individual production instruction information that is transmitted from the server 12 to the client 20 includes the production lot number of a master roll of a photographic film material that matches the type of products indicated by production plan data. A master roller having the same production log number is supplied from among master rolls stored in a storage chamber to the cutting machine 40 by a self-powered carriage or the like.

The client 20 sends operating conditions such as slitting conditions, e.g., the speed at which the master roll is to be fed and the inspecting conditions for a surface inspection device in the cutting machine 40, to the cutting machine 40. Based on the operating conditions supplied from the client 20, the cutting machine 40 cuts off the master roll to a certain width, thereby producing a slit roll.

At this time, a plurality of slit rolls are produced from the single master roll. In order to identify the slit rollers at a subsequent process, a label bearing a printed bar code indicative of an emulsion number, a master roll production lot number, and a slit roll number is produced each time a slit roll is completed, and produced labels are applied to the respective slit rolls. The bar codes are read by a bar-code reader, which enter bar code data into the client 20.

The slit roll is supplied to the winding machine 42 controlled by the client 22, and placed in a cartridge case.

The individual production instruction information that is transmitted from the database memory 122 of the server 12 includes the emulsion number, the master roll production lot number, and the slit roll number of the slit roll that is used.

The winding machine 42 removes the slit roll that is indicated by the individual production instruction information from a storage chamber, and sets the slit roll in place. The winding machine 42 reads the bar code applied to the slit roll set in place and confirms whether the bar code corresponds to the indicated slit roll. The winding machine 42 also sends information of how much the preceding slit roll has been consumed to the server 12 via the client 22. The client 22 then operates the winding machine 42 according to the conditions indicated by the individual production instruction information from the server 12.

The winding machine 42 has a perforator and a side printer. The perforator forms perforations in the slit roll according to an indicated format. The side printer records a latent image of production information on the slit roll. The production information includes a film ID number, frame numbers, an abbreviated product name, a manufacturer's name, etc. recorded in the form of a bar code. The film ID number is saved together with the order number of production plan data in the server 14, and also transmitted to the server 12 and written in the production instruction information that is transmitted to the client 22 which controls the winding machine 42.

When the side printer prints the film ID number, the film ID number is fed back together with the other side print information to the client 22, which confirms whether the supplied film ID number is the same as the film ID number indicated by the individual production instruction information or not. The client 22 transmits the other information obtained so far, i.e., the emulsion number, the master roll production lot number, and the slit roll number is, in association with the film ID number, to the server 12. The transmitted information is saved in the server 12 and also transmitted to the server 14.

The cutting machine 42 also has a cutter and a winder. After the side printer has printed the necessary information, the cutter cuts off an elongate photographic film unwound from the slit roll into a length corresponding to the number of exposure frames, thus producing a photographic film strip. The cutter operates under manufacturing conditions included in the individual production instruction information sent via the server 12 to the client 22.

The photographic film strip is then fed to the winder which is also supplied with a tray of cartridge cases that have been molded and assembled by the molding and assembling machine 44 from a stacking station. The tray has a tray ID number, which is read and supplied via the client 22 to the server 12.

The server 12 stores cartridge ID numbers and manufacturing history information of the cartridge cases on the tray, in association with the tray ID number. Therefore, the server 12 can confirm, based on the stored information, the range of cartridge ID numbers to which the cartridge cases supplied to the winding machine 42 belong, the order number based on which the cartridge cases have been manufactured, and the production lot numbers of parts which the cartridge cases are assembled of.

When the cartridge cases are successively supplied to the winder, the cartridge ID numbers are read from bar codes on labels applied the cartridge cases, and immediately entered into the client 22.

The cartridge case in the bar-code reading position is a cartridge case to be combined with the photographic film strip that is to be printed next by the side printer. Therefore, the client 22 confirms the cartridge ID number immediately before the side printer prints information on the photographic film strip.

The cartridge ID number thus read is transmitted to the server 12, which compares the cartridge ID number with a film ID number to be allotted to the photographic film strip by the side printer. Since the server 12 holds film ID numbers and cartridge ID numbers assigned to products to be manufactured when the production plan data is generated, the server 12 is capable of determining whether the cartridge ID number of the cartridge case supplied to the winder is appropriate or not.

When the winder operates, the trailing end of the photographic film strip engages a spool in the cartridge case, and then the spool is rotated to wind the photographic film strip into the cartridge case. Thereafter, a light shielding lid of the cartridge case is closed, completing a photographic film cartridge as a product.

Since the manufacturing history information of the photographic film strip, including the emulsion number, the master roll production lot number, and the slit roll number is already known, the manufacturing history information of the cartridge case and the photographic film strip is saved, as production management information in association with the cartridge ID number or the film ID number, via the server 12 into the server 14.

A certain number of photographic film cartridges thus produced are placed on a tray, and stored in a stacking station. At this time, the tray ID number of the tray is read and transmitted to the client 22, which associates the tray ID number with the ID numbers of the photographic film cartridges on the tray, i.e., the cartridge ID numbers or the film ID numbers, information as to usage and lack of the ID numbers of the photographic film cartridges, and manufacturing history information, and feeds back the associated information to the server 12. The server 12 transmits the associated information to the server 14.

Therefore, the information that represents the ID numbers of the photographic film cartridges stored in the stacking station, the types of the products, and the manufacturing histories of the photographic film strips and the cartridge cases, can be recognized in association with the tray ID number.

The client 24 controls the encasing machine 46 and the small box supply apparatus 48. A photographic film cartridge is supplied from the winding machine 42 to the encasing machine 46 in which the photographic film cartridge is placed in a film case and then stored in a small box.

The production instruction information from the server 12 indicates the production lot number to which the film case that is used belongs. The production log number of the film case that is used is sent via the client 24 to the server 12.

The small box bears an indication and a bar code which indicate the type of the product. The bar cord indicating the type of the product is printed when the small box is produced. However, a bar code indicating a packing material ID number of the small box is printed when the small box is supplied from the small box supply apparatus 48 to the encasing machine 46.

The packing material ID number to be printed is determined by the server 14 at the time the production plan is generated. As with the side printing of the film ID number, the packing material ID number is printed after it is confirmed that the cartridge ID number of the photographic film cartridge to be packed and the packing material ID number transmitted as the production instruction information agree with each other.

The photographic film cartridge packed in the small box is then delivered to the packaging machine 50 that is controlled by the client 26. The packaging machine 50 is supplied with a packaging cardboard box from the cardboard box supply apparatus 52, and packages 1000 photographic film cartridges, for example, in the cardboard box.

The packaging machine 50 has a packaging unit which prints a package ID number as a bar code on the cardboard box at the time the photographic film cartridges or products are packaged in the cardboard box. The package ID number is determined by the server 14, as with the packing material ID number. One package ID number is assigned to 1000 products to be packaged in the cardboard box with respect to the range of used packing material ID numbers printed by the encasing machine 46. The association between the package ID number and the 1000 products is saved in the server 14. Therefore, when the package ID number is read from the cardboard box, it is possible to recognize the range of used packing material ID numbers of the products packaged in the cardboard box.

The clients 30, 32 perform tasks including production plans, raw material purchase management processes, and product inventory management processes between themselves and the server 14. The clients 30, 32 are operated by the operator in a production management department to transmit the production instruction information to the server 12 and generate production management data from the manufacturing history data of the products that have been collected and transmitted by the server 12.

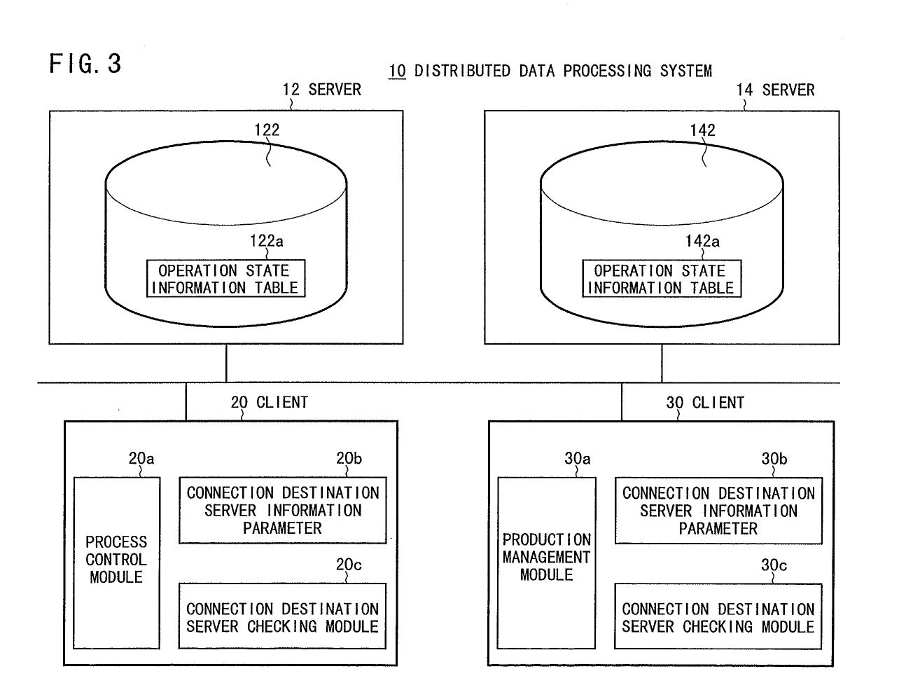

A distributed data processing process based on a system configuration of the clients 20, 30 shown in FIG. 3 will be described below. Since the clients 22, 24, 26, 32 have the same system configuration, a distributed data processing process based thereon will not be described below.

The client 20 has a process control module 20a for controlling the cutting machine 40, a connection destination server information parameter 20b (connection information manager), and a connection destination server checking module 20c (connection information changer). Similarly, the client 30 also has a process control module 30a for controlling the production management, a connection destination server information parameter 30b (connection information manager), and a connection destination server checking module 30c (connection information changer). The servers 12, 14 have respective operation state information tables 122a, 142a.

When the distributed data processing system 10 is in normal operation, the client 20 is connected to the server 12 and controls the process of the production line, and the client 30 is connected to the server 14 and performs the task of the production management. The connection destination server information parameter 20b of the client 20 represents the server 12 as a default setting, with the server 14 indicated as a backup server. Conversely, the connection destination server information parameter 30b of the client 30 represents the server 14 as a default setting, with the server 12 indicated as a backup server.

When the distributed data processing system 10 is activated, the connection destination server checking module 20c of the client 20 checks the server represented by the connection destination server information parameter 20b, i.e., the server 12 initially indicated as a default setting. Specifically, the connection destination server checking module 20c confirms the operation state information table 122a of the server 12 indicated as a default setting, and establishes a connection if the server 12 is in normal operation. The client 30 operates in the same manner.

If the server 12 is not in normal operation, then the connection destination server checking module 20c confirms the operation state information table 142a of the server indicated as a backup server, i.e., the server 14, and establishes a connection if the server 14 is in normal operation. If both the servers 12, 14 are not in normal operation, then a connection error is displayed, and the distributed data processing system 10 is shut off.

When a connection is established, the connection destination server checking module 20c indicates connection port information to the process control module 20a. Subsequently, the connection destination server checking module 20c periodically polls the operation state information table 122a, and if the connection destination server stops its operation, then the application of the client 20, i.e., the process control module 20a, is automatically stopped. The client 30 also operates in the same manner.

If one of the servers suffers a failure and stops its operation while the distributed data processing system 10 is normally operating, the client 20 or 30 which has been connected to the shut-off server is automatically stopped. For example, if the server 12 is shut off due to a fault, then the operator operates the client 20 that has been shut off to activate connection destination management software (not shown) to change a connection destination from the server 12, which has been established as a default setting by the connection destination server information parameter 20b, to the server 14, which has been established as a backup server.

The connection destination management software of the client 20 is configured to appoint the server 12 as a server to be connected in a normal situation and the server 14 as a server to be connected upon fault. The connection destination server checking module 20c refers to the operation state information table 142a of the server 14, and establishes a connection to the server 14.

At this time, the database memory 122 of the server 12 and the database memory 142 of the server 14 stores the same data, as described la ter on, and hence the process control processing can continuously been performed even though the client 20 is connected to the server 14. This holds true when the server 14 stops its operation due to a failure. Consequently, the film manufacturing process is continued without fail even if either one of the servers 12, 14 suffers a fault.

A backup process in the normal operation of the distributed data processing system 10 will be described below with reference to FIGS. 1, 4, and 5.

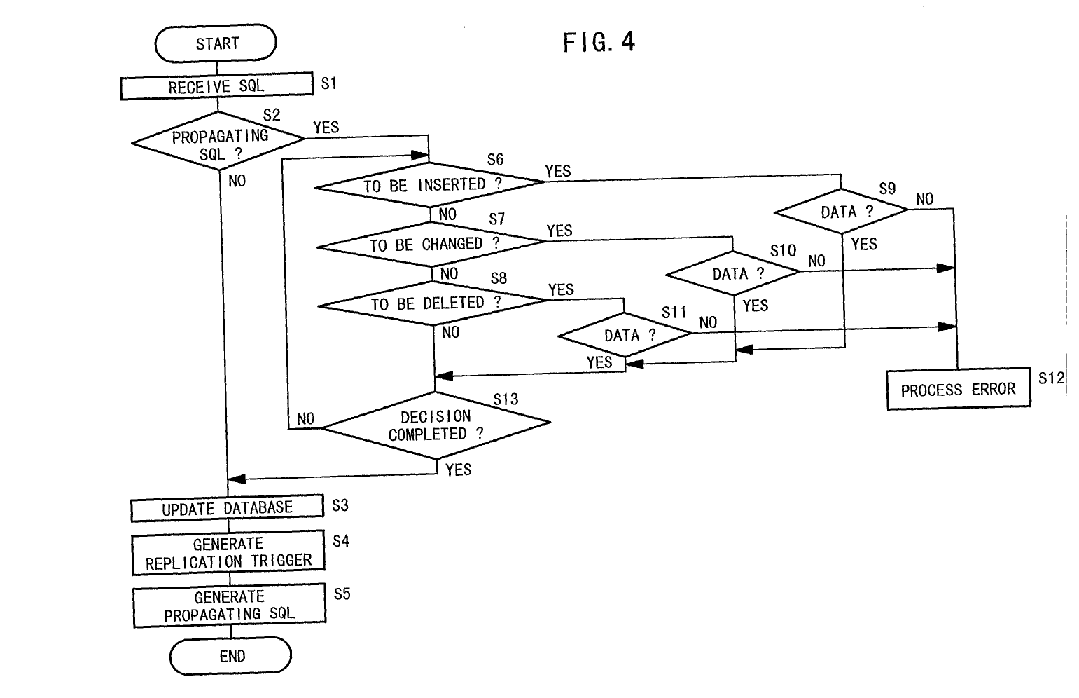

In the flowchart of FIG. 4, if an updating request for inserting data into, changing data in, or deleting data from, the database stored in the database memory 122 occurs as a result of the control process effected by the clients 20, 22, 24, 26 on the cutting machine 40 or other controlled machines, or as a result of an action made by the operator, then the database updating processor 128 of the server 12 receives an SQL (Structured Query Language) indicative of updating information generated upon the updating request in step S1. Then, the database updating processor 128 determines whether the received SQL is an updating SQL for updating the database of the its own database memory 122 or a propagating SQL for updating the database of the its own database memory 124 of the other server 14 in step S2.

If the received SQL is an updating SQL, then the database updating processor 128 inserts data into, changes data in, or deletes data from, the database stored in the database memory 122 according to the instruction of the SQL in step S3, and instructs the replication trigger generator 132 to generate a replication trigger. The instructed replication trigger generator 132 generates a replication trigger to replicate the database in step S4. Based on the replication trigger, the replication trigger generator 132 converts the updating SQL into a propagating SQL, and supplies the propagating SQL to the updating information transfer unit 130 in step S5.

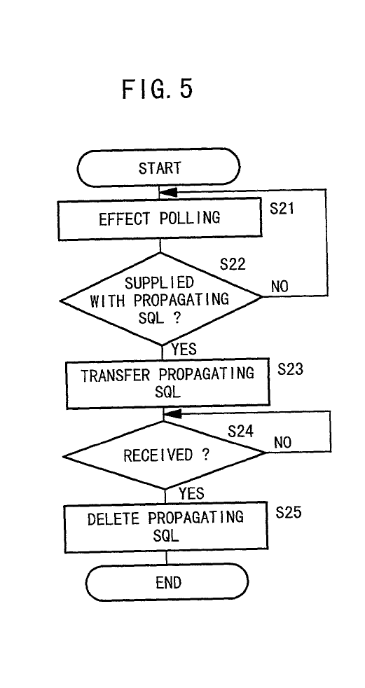

In the flowchart of FIG. 5, the updating information transfer unit 130 performs a polling process at certain time intervals in step S21. If the updating information transfer unit 130 is supplied with the propagating SQL from the replication trigger generator 132 in step S22, then the updating information transfer unit 130 transfers the propagating SQL to the database updating processor 148 of the server 14 in step S23. If the updating information transfer unit 130 receives an acknowledgement signal acknowledging the propagating SQL from the database updating processor 148 in step S24, then the updating information transfer unit 130 deletes its own propagating SQL in step S25.

In FIG. 4, the database updating processor 148 determines whether the SQL received in step Si is an updating SQL generated by clients 30, 32 or a propagating SQL transferred from the other server 12 in step S2.

If the received SQL is a propagating SQL, then the database updating processor 148 determines whether the updating information of the propagating SQL represents a data insertion or not in step S6, whether the updating information of the propagating SQL represents a data change or not in step S7, and whether the updating information of the propagating SQL represents a data deletion or not in step S8. The database updating processor 148 also determines whether the changing information has data or not in steps S9, S10, S11. If the changing information has no data, then the transferring process is judged as suffering a fault, and an error is processed in step S12.

After the above processing is performed on all propagating SQLs in step S13, the database in the database memory 142 is updated in step S3. In this case, the database updating processor 148 issues a replication trigger generation inhibiting instruction to the replication trigger generator 152. The replication trigger generation inhibiting instruction inhibits updating information based on the propagating SQL from being transferred from the updating information transfer unit 150 to the server 12.

In this manner, the databases stored in the respective database memories 122, 142 of the servers 12, 14 are maintained as an identical database, though asynchronously.

In a distributed data processing system which performs asynchronously processing, a conflict of data may be anticipated. In the distributed data processing system 10 according to the present embodiment, however, such conflict of data can be prevented since a function of the production management system and a function of the process control system are clearly distinguished in normal operation based on each database to be connected. That is, each SQL for inserting, updating, or deleting data generated by a client connected to the database is not processed against the same record that a propagating SQL for inserting, updating, or deleting data is processed against.

The backup processors 123, 143 of the servers 12, 14 copy the databases stored in the respective database memories 122, 142 to the backup data memories 124, 144 at certain intervals, e.g., intervals of a day, i.e., 24 hours, while in operation, generating backup data for the database memories 122, 142. Different processes are available for backing up the backup data for the database memories 122, 142. Such backup processes include, for example, a full backup process for backing up all the data in the database memories 122, 142 once, a differential backup process for backing up only files with data updated or only data generated after the preceding full backup cycle, and an incremental backup process for backing up only files with data updated or only data generated after the preceding full backup cycle or the preceding differential backup cycle. The backup data for the database memories 122, 142 are generated according to either one of these available different backup processes.

At time the backup data start being generated, the archive data generators 125, 145 discard the data in the archive data memories 126, 146 which have accumulated the updating information of the databases so far. Thereafter, the archive data generators 125, 145 start recording newly updated data in the database memories 122, 142 as archive data in the archive data memories 126, 146.

The backing up of the databases in the backup data memories 124, 144 is carried out using a file copy function of the servers 12, 14 at the OS level. Unlike the export function which converts structural information and data of the database memories 122, 142 into respective different forms and outputs them as files, the file copy function copies the databases as they are, and takes a short time to back up the databases though it needs a large hard disk resource.

For example, whereas the export function requires about 600 minutes to back up a database having 3 gigabytes of data, the file copy function needs only 60 minutes, one-tenth of the 600 minutes, to back up the same database. For generating backup data according to the file copy function, however, it is necessary to use identical settings and file names for the files of the database memories 122, 142 and the data of the backup data memories 124, 144.

With the above arrangement, backup data are generated while the servers 12, 14 are operating, and new updating information for the database memories 122, 142 after the backup data have started to be generated is recorded in the archive data memories 126, 146. Thus, the database memories 122, 142 can be backed up efficiently in a short period of time. If a fault such as a database data breakdown, as described below, occurs, then the database data can quickly be recovered using the backup data and the archive data.

A process of recovering the data in the event of a fault such that that the data of the database memory 142 of the server 14 is destructed will be described below.

The clients 30, 32 connected to the server 14 have its connection destination changed to the server 12, and the distributed data processing system 10 is operated with the server 12 alone. The production process can thus be continued without a system shutdown. Then, the hardware arrangement of the faulty server 14 is restored. For example, the hard disk of the database memory 142, for example, is replaced with a new one.

Thereafter, the data in the backup data memory 124 is restored on the database memory 142 by way of file copying. Through this operation, a replication of the database in the database memory 122 at the time the database memory 122 is backed up is constructed in the database memory 142. During this processing, archive data after the start of the backup process in the operation is recorded in the archive data memory 126.

The operation to restore the data in the backup data memory 124 on the database memory 142 is carried out using the file copy function. Therefore, the databases including settings in the database memories 122, 142 are made fully identical to each other and stored in hard disk drives of the same name. In order to take over the processing of the client connected to one of the servers which suffers a fault, it is necessary to use a different global name for access from an external source.

After the copying process for the backup data is completed, all the clients 20, 22, 24, 26, 30, 32 connected to the server 12 is temporarily shut off in order to prevent the database memory 122 from being updated. Then, the archive data accumulated in the archive data memory 126 are applied to, i.e., written in, the database memory 142. This writing process is automatically performed according to a so-called roll-forward function. This roll-forward function is the same as the roll-forward function incorporated in general database processing software. This operation restores the data in the database memories 122, 142 to the same data.

After the completion of the above restoring process, the clients 30, 32 are connected again to the server 14, and the servers 12, 14 are activated again to resume operation of the entire distributed data processing system 10.

The distributed data processing system 10 is fully out of operation only while the archive data except the backup data is being applied to the database. If the time interval to back up the archive data during operation is set to one day, then the amount of the archive data is equal to at most the amount of database data updated in one day. The time required to restore the database from the achieve data ranges from several minutes to several tens of minutes. Therefore, the period of time in which the distributed data processing system 10 is shut off may also be reduced to the time ranging from several minutes to several tens of minutes. The system downtime is thus made much shorter than the time, i.e., about 8 hours, required to recover the database according to the conventional export and import functions.

Although a certain preferred embodiment of the present invention has been shown and described in detail, it should be understood that various changes and modifications may be made therein without departing from the scope of the appended claims.

What is claimed is:

1. A distributed data processing system comprising a plurality of servers and a plurality of clients connected to the servers for performing a distributed data processing process on an object to be controlled,
each of said servers comprising:
a database memory for storing a database which is updated by the distributed data processing process performed by said clients;
a replication trigger generator for generating a replication trigger based on the updating of said database by the distributed data processing process performed by said clients;
an updating information transfer unit for transferring updating information of said database to another one of the servers based on said replication trigger; and
a database updating processor for updating said database based on the updating information transferred from the other server.

2. A distributed data processing system according to claim 1, wherein each of said clients comprises:
a connection information manager for managing connection information of a connection destination server to which the clients are connected; and
a connection information changer for changing the connection information of the connection destination server;
the arrangement being such that if any of said servers suffers a fault, said connection information is changed by said connection information changer, and the distributed data processing process performed by the clients connected to the server which suffers the fault is continued under the management of another normal one of the servers to which said connection information is changed.

3. A distributed data processing system according to claim 1, further comprising:
a backup processor for performing backup process at predetermined time intervals while said database is in operation;
a backup data memory for storing backup data produced by the backup process performed while said database is in operation;
an archive data generator for generating archive data based on the updating information of the database which is generated after the backup process performed while said database is in operation has started; and
an archive data memory for storing the archive data;
the arrangement being such that said database is recovered based on said backup data and said archive data.

4. A distributed data processing system according to claim 2, further comprising:
a backup processor for performing backup process at predetermined time intervals while said database is in operation;
a backup data memory for storing backup data produced by the backup process performed while said database is in operation;
an archive data generator for generating archive data based on the updating information of the database which is generated after the backup process performed while said database is in operation has started; and
an archive data memory for storing the archive data;
the arrangement being such that said database is recovered based on said backup data and said archive data.

5. A distributed data processing system according to claim 1, wherein said servers comprise:
a server for managing one of the clients which is of a production management system which is of the object to be controlled; and
a server for managing one of the clients which is of a process control system which is of the object to be controlled.

6. A distributed data processing system according to claim 5, wherein each of said servers has independent settings of distributed data processing so that said database can be independently processed in inserting, updating, or deleting data.

7. A method of processing data in a distributed data processing system having a plurality of servers and a plurality of clients connected to the servers for performing a distributed data processing process on an object to be controlled, comprising the steps of:
updating a database according to the distributed data processing process performed by said clients;
generating a replication trigger based on the updating of said database by the distributed data processing process performed by said clients;
transferring updating information of said database to another one of the servers based on said replication trigger; and
updating said database based on the updating information transferred from the other server.

8. A method according to claim 7, further comprising the steps of:
if any of said servers suffers a fault, changing a connection destination of the clients connected to the server which suffers the fault to another normal one of the servers; and
continuing the distributed data processing process performed by the clients connected to the server under the management of the other normal server.

9. A method according to claim 8, further comprising the step of activating again said server suffering the fault to resume normal operation after completion of a restoring process, said step of activating again said server comprising the steps of:
shutting off all the clients connected to said server;
setting again information of the connection destination of the clients;
connecting the clients to said server according to the set information; and
resuming the distributed data processing process in a normal connection state.

10. A method according to claim 7, further comprising the steps of:
performing a backup process at predetermined time intervals while said database is in operation and saving backup data produced by the backup process performed;
generating and saving archive data based on the updating information of the database which is generated after the backup process performed while said database is in operation has started; and
if one of said servers suffers a fault, copying said backup data of another normal one of the servers, and recovering the database from said archive data of the other normal server.

11. A method according to claim 10, further comprising the step of:
copying said backup data while the clients are being continuously operated by said other normal server.

12. A method according to claim 8, further comprising the steps of:
performing a backup process at predetermined time intervals while said database is in operation and saving backup data produced by the backup process performed;
generating and saving archive data based on the updating information of the database which is generated after the backup process performed while said database is in operation has started; and
if one of said servers suffers a fault, copying said backup data of another normal one of the servers, and recovering the database from said archive data of the other normal server.
